(19) United States
(12) Patent Application Publication
(10) Pub. No.: US 2011/0221797 A1
(43) Pub. Date: Sep. 15, 2011

(54) IMAGE DISPLAY DEVICE

(76) Inventor: Ken Inada, Osaka (JP)

(21) Appl. No.: 13/130,083

(22) PCT Filed: Oct. 2, 2009
(86) PCT No.: PCT/JP2009/067222

§ 371 Date: May 19, 2011

(30) Foreign Application Priority Data
Nov. 20, 2008 (JP) 2008-296215

(51) Int. Cl. G09G 5/10

(52) U.S. Cl. 345/690

(57) ABSTRACT

Pixel circuits 6 have a rectangular shape longer in an extending direction of scanning signal lines than in an extending direction of data signal lines. Three pixel circuits 6 arranged in the extending direction of data signal lines form one pixel. A pixel having three pixel circuits 6 arranged in the order red, green, and blue, a pixel having three pixel circuits 6 arranged in the order green, blue, and red, and a pixel having three pixel circuits 6 arranged in the order blue, red, and green are repeatedly arranged in the extending direction of scanning signal lines. By this, when line inversion drive is performed using a data signal line drive circuit 4, voltages of different polarities are applied to three types of pixel circuits 6 in each line in each frame to cancel out the influence of the polarities of the applied voltages, thereby suppressing a color shift.

### TECHNICAL FIELD

The present invention relates to an image display device, and more particularly to an image display device that performs color display using pixel circuits longer in an extending direction of scanning signal lines than in an extending direction of data signal lines.

### BACKGROUND ART

As an image display device that performs color display, a liquid crystal display device including three types of pixel circuits associated with red, green, and blue is widely used. The pixel circuits included in the liquid crystal display device have a rectangular shape. A liquid crystal display device generally uses, as shown in FIG. 10, pixel circuits longer in an extending direction of data signal lines than in an extending direction of scanning signal lines (hereinafter, referred to as the vertically long pixel circuits). In this case, three types of pixel circuits are disposed side by side in the extending direction of scanning signal lines. When the number of pixels in a vertical direction of a display screen is m and the number of pixels in a horizontal direction is n, (m×n×3) pixel circuits are disposed such that 3n pixel circuits are in the extending direction of scanning signal lines and in pixel circuits are in the extending direction of data signal lines. The (m×n×3) pixel circuits are driven using m scanning signal lines and 3n data signal lines.

Meanwhile, as shown in FIG. 11, pixel circuits longer in an extending direction of scanning signal lines than in an extending direction of data signal lines (hereinafter, referred to as the horizontally long pixel circuits) can also be used. In this case, three types of pixel circuits are disposed side by side in the extending direction of data signal lines. The (m×n×3) pixel circuits are disposed such that n pixel circuits are in the extending direction of scanning signal lines and 3m pixel circuits are in the extending direction of data signal lines. The (m×n×3) pixel circuits are driven using 3m scanning signal lines and n data signal lines.

As such, when horizontally long pixel circuits are used, although the number of scanning signal lines is three times more than that for the case of using vertically long pixel circuits, the number of data signal lines is 1/3 . In general, the amount of circuitry per data signal line is larger than the amount of circuitry per scanning signal line. Therefore, when horizontally long pixel circuits are used, although writing time to the pixel circuits is shortened over the case of using vertically long pixel circuits, the amount of circuitry of a data signal line drive circuit is reduced. By this, the widths of frame portions present, at the top and bottom of a display screen can be reduced.

Techniques related to the invention of the present application are described in the following Patent Documents. Patent Document 1 describes an image display device having a horizontal stripe configuration, in which one frame image is divided into three sub-fields and pixels of respective colors are rewritten in different orders in different sub-fields. Patent Document 2 describes an image display device having a horizontal stripe configuration, in which a gamma conversion characteristic provided to a video signal is changed in accordance with the selection of a scanning signal line. Patent Document 3 describes a liquid crystal display device of an FFS (Fringe Field Switching) scheme having a horizontal stripe configuration.

### RELATED ART DOCUMENTS

### Patent Documents

[Patent Document 1] Japanese Laid-Open Patent Publication No. 9-80466
[Patent Document 2] Japanese Laid-Open Patent Publication No. 2006-317566
[Patent Document 3] Japanese Laid-Open Patent Publication No. 2007-248999

### SUMMARY OF THE INVENTION

### Problems to be Solved by the Invention

In order to prevent screen burn-in, a liquid crystal display device performs polarity inversion drive where the polarities of liquid crystal applied voltages are reversed in a predetermined cycle. The polarity inversion drive includes frame inversion drive where the polarities are reversed on a frame-by-frame basis; line inversion drive where the polarities are reversed on a line-by-line basis; dot inversion drive where the polarities are reversed on a dot-by-dot basis; and the like.

However, when line inversion drive is performed by a liquid crystal display device including horizontally long pixel circuits, a color shift may occur when a horizontal line is displayed on a screen. For example, the case is considered in which a liquid crystal display device having disposition of pixel circuits shown in FIG. 12 performs one-line inversion drive where the polarities of liquid crystal applied voltages are reversed on a line-by-line basis, and displays a screen shown in FIG. 13. The display screen shown in FIG. 13 includes a white horizontal line with a one-line width (one-pixel width) on a black background, and the horizontal line moves upward at a rate of one line per frame time. The horizontal line looks white at rest, but looks a different color than white (e.g., a yellowish color) when moving at the above-described rate.

This color shift is caused by performing one-line inversion drive. FIG. 14 is a diagram showing the polarities of liquid crystal applied voltages for the case of performing one-line inversion drive. As shown in FIG. 14, for the odd-numbered lines, negative polarity voltages are applied to pixel circuits associated with red or blue, and positive polarity voltages are applied to pixel circuits associated with green. For the even-numbered lines, positive polarity voltages are applied to pixel circuits associated with red or blue, and negative polarity voltages are applied to pixel circuits associated with green. Since frame inversion drive is also performed with one-line inversion drive, in the next frame, the polarities of liquid crystal applied voltages are reversed from those shown in FIG. 14.

When a horizontal line is at rest, regardless of in which line the horizontal line is, a positive polarity voltage and a negative polarity voltage are alternately applied, on a frame-by-frame basis, to all pixel circuits located in the position of the horizontal line. Hence, the colors are averaged between two frames, making the horizontal line look white. In contrast to this, when the horizontal line moves at a rate of one line per frame time, voltages of the same polarity are applied to all pixel circuits located in the position of the horizontal line. For example, it is assumed that a horizontal line is present in an odd-numbered line in a given frame, and negative polarity voltages are applied to pixel circuits associated with red or blue located in the position of the horizontal line and positive polarity voltages are applied to pixel circuits associated with green. In this case, in the next frame, the horizontal line moves to an even-numbered line, and thus, negative polarity voltages are applied again to pixel circuits associated with red or blue located in the position of the horizontal line and positive polarity voltages are applied again to pixel circuits associated with green. As such, since voltages of the same polarity are applied to all pixel circuits located in the position of a horizontal line in every frame, the horizontal line looks a color different than white.

This color shift occurs remarkably when a horizontal line with a one-line width is displayed. Whether or not a color shift occurs depends on the cycle of line inversion drive (every how many lines the polarities of liquid crystal applied voltages are to be reversed) and the moving rate of a horizontal line. For example, in FIG. 13, when the horizontal line moves at a rate of two lines per frame time, a color shift does not occur. When such a color shift occurs, the image quality of a display screen degrades.

An object of the present invention is therefore to suppress a color shift which occurs when line inversion drive is performed by an image display device including pixel circuits longer in an extending direction of scanning signal lines.

### Means for Solving the Problems

According to a first aspect of the present invention, there is provided an image display device that performs color display, the image display device including: a plurality of scanning signal lines extending in a first direction; a plurality of data signal lines extending in a second direction; a plurality of pixel circuits provided at respective intersections of the scanning signal lines and the data signal lines, the pixel circuits being longer in the first direction than in the second direction; a scanning signal line drive circuit that selects the scanning signal lines in turn; and a data signal line drive circuit that applies voltages generated according to a video signal to the data signal lines such that polarities of the voltages are switched every one or more data signal lines, wherein a predetermined number of pixel circuits arranged in the second direction each are associated with a given color, and as a whole form one pixel, and an order of arrangement of pixel circuits differs between pixels adjacent to each other in the first direction.

According to a second aspect of the present invention, in the first aspect of the present invention, pixels where an order of arrangement of pixel circuits changes regularly are arranged in the first direction.

According to a third aspect of the present invention, in the second aspect of the present invention, a pixel having three pixel circuits arranged in an order red, green, and blue, a pixel having three pixel circuits arranged in an order green, blue, and red, and a pixel having three pixel circuits arranged in an order blue, red, and green are repeatedly arranged in the first direction, the three pixel circuits being associated with red, green, and blue.

According to a fourth aspect of the present invention, in the second aspect of the present invention, a pixel having three pixel circuits arranged in an order red, green, and blue and a pixel having three pixel circuits arranged in an order green, red, and blue are alternately arranged in the first direction, the three pixel circuits being associated with red, green, and blue.

According to a fifth aspect of the present invention, in the first aspect of the present invention, pixels with the same order of arrangement of pixel circuits are arranged in the second direction.

According to a sixth aspect of the present invention, in the first aspect of the present invention, the data signal line drive circuit applies the voltages generated according to the video signal to the data signal lines such that the polarities of the voltages are switched every one data signal line.

### Effect of the Invention

According to the first aspect of the present invention, the order of arrangement of pixel circuits differs between pixels adjacent to each other in the extending direction of scanning signal lines. Thus, when line inversion drive is performed, voltages of different polarities are applied to pixel circuits associated with the respective colors in each line in each frame, whereby the influence of the polarities of the applied voltages can be canceled out. By this, a color shift can be suppressed which occurs when line inversion drive is performed by an image display device including pixel circuits longer in the extending direction of scanning signal lines.

According to the second aspect of the present invention, by arranging pixels where the order of arrangement of pixel circuits changes regularly, in the extending direction of scanning signal lines, when line inversion drive is performed, voltages of different polarities are regularly applied to pixel circuits associated with the respective colors in each line in each frame to suitably cancel out the influence of the polarities of the applied voltages, whereby a color shift can be effectively suppressed.

According to the third aspect of the present invention, when line inversion drive is performed by an image display device including pixel circuits associated with red, green, and blue, voltages of different polarities are regularly applied to three types of pixel circuits in each line in each frame, to suitably cancel out the influence of the polarities of the applied voltages, whereby a color shift can be effectively suppressed.

According to the fourth aspect of the present invention, when line inversion drive is performed by an image display device including pixel circuits associated with red, green, and blue, voltages of different polarities are alternately applied to pixel circuits associated with red and green to which human has high sensitivity, in each line in each frame to suitably cancel out the influence of the polarities of the applied voltages, whereby a color shift can be effectively suppressed.

According to the fifth aspect of the present invention, a color shift can be suppressed which occurs when line inversion drive is performed by an image display device in which pixels of the same configuration are arranged in the extending direction of data signal lines.

According to the sixth aspect of the present invention, when one-line inversion drive is performed, voltages of different polarities are applied to pixel circuits associated with the respective colors in each line in each frame to cancel out the influence of the polarities of the applied voltages, whereby a color shift can be suppressed.

### BRIEF DESCRIPTION OF THE DRAWINGS

FIG. 1 is a block diagram showing a configuration of a liquid crystal display device according to an embodiment of the present invention.

FIG. 2 is a diagram showing the disposition of pixel circuits in the liquid crystal display device shown in FIG. 1.

FIG. 3 is a diagram showing the polarities of liquid crystal applied voltages in the liquid crystal display device shown in FIG. 1.

FIG. 4 is a diagram showing the disposition of pixel circuits in a liquid crystal display device according to a first variant of the present invention.

FIG. 5 is a diagram showing the polarities of liquid crystal applied voltages in the liquid crystal display device according to the first variant of the present invention.

FIG. 6 is a diagram showing the disposition of pixel circuits in a liquid crystal display device according to a second variant of the present invention.

FIG. 7 is a diagram showing the disposition of pixel circuits in a liquid crystal display device according to a third variant of the present invention.

FIG. 8 is a diagram showing the disposition of pixel circuits in a liquid crystal display device according to a fourth variant of the present invention.

FIG. 9 is a diagram showing the disposition of pixel circuits in a liquid crystal display device according to a fifth variant of the present invention.

FIG. 10 is a diagram showing the disposition of vertically long pixel circuits in a conventional liquid crystal display device.

FIG. 11 is a diagram showing the disposition of horizontally long pixel circuits in a conventional liquid crystal display device.

FIG. 12 is a diagram showing the disposition of horizontally long pixel circuits in a conventional liquid crystal display device.

FIG. 13 is a diagram showing an example of a display screen where a color shift occurs.

FIG. 14 is a diagram showing the polarities of liquid crystal applied voltages in a conventional liquid crystal display device.

### MODE FOR CARRYING OUT THE INVENTION

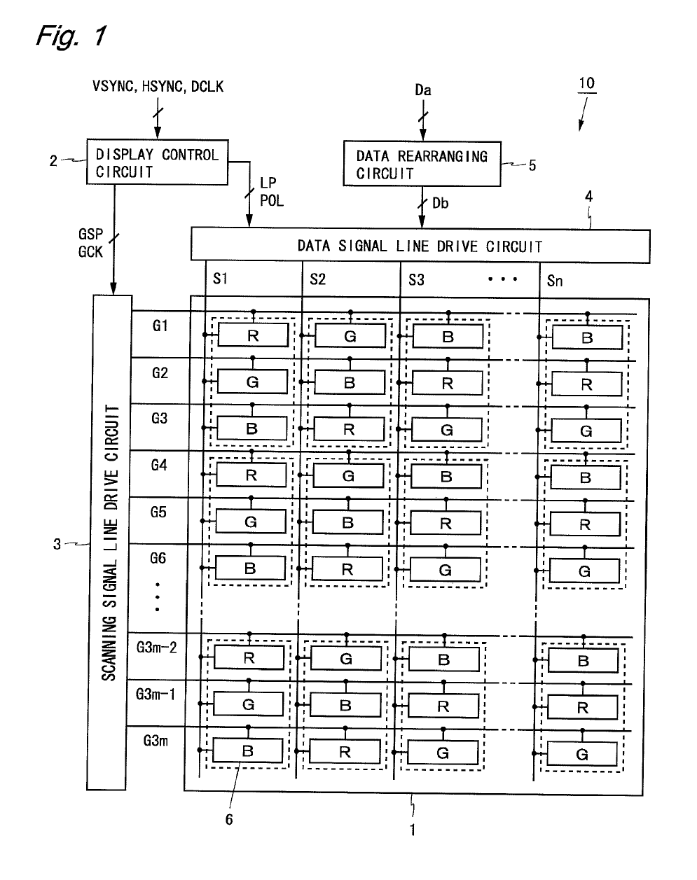

FIG. 1 is a block diagram showing a configuration of a liquid crystal display device according to an embodiment of the present invention. A liquid crystal display device 10 shown in FIG. 1 includes a liquid crystal panel 1, a display control circuit 2, a scanning signal line drive circuit 3, a data signal line drive circuit 4, and a data rearranging circuit 5. The liquid crystal display device 10 displays a screen of m pixels in a vertical direction by n pixels in a horizontal direction (note that m and n are integers greater than or equal to 2).

In the liquid crystal panel 1 are provided 3m scanning signal lines G1 to G3m disposed parallel to one another; and n data signal lines S1 to Sn disposed parallel to one another so as to intersect perpendicularly with the scanning signal lines G1 to G3m. The scanning signal lines G1 to G3m extend in a first direction (a lateral direction in FIG. 1) and the data signal lines S1 to Sn extend in a second direction (a longitudinal direction in FIG. 1) perpendicular to the first direction. The extending direction of the scanning signal lines G1 to G3m is hereinafter referred to as the row direction, and the extending direction of the data signal lines S1 to Sn is hereinafter referred to as the column direction.

The scanning signal lines G1 to G3m intersect with the data signal lines S1 to Sn at (m×n×3) locations, and pixel circuits 6 are provided at the respective intersections. The pixel circuits 6 have a rectangular shape longer in the row direction than in the column direction. A total of (m×n×3) of such horizontally long pixel circuits 6 are provided in the liquid crystal panel 1 such that n pixel circuits 6 are in the row direction and 3m pixel circuits 6 are in the column direction.

In the liquid crystal display device 10 is provided a color filter (not shown) having (m×n) regions that allow red light to be transmitted therethrough, (m×n) regions that allow green light to be transmitted therethrough, and (m×n) regions that allow blue light to be transmitted therethrough, in association with the (m×n×3) pixel circuits 6. By providing such a color filter, each pixel circuit 6 functions as any of a pixel circuit associated with red, a pixel circuit associated with green, and a pixel circuit associated with blue (hereinafter, referred to as the R pixel circuit, G pixel circuit, and B pixel circuit, respectively).

A vertical synchronizing signal VSYNC, a horizontal synchronizing signal HSYNC, a dot clock DCLK, a video signal Da, etc., are inputted from the outside of the liquid crystal display device 10. The display control circuit 2 outputs control signals for the scanning signal line drive circuit 3 and the data signal line drive circuit 4, based on the vertical synchronizing signal VSYNC, the horizontal synchronizing signal HSYNC, the dot clock DCLK, etc. The control signals for the scanning signal line drive circuit 3 include a gate start pulse GSP, a gate clock GCK, etc. The control signals for the data signal line drive circuit 4 include a latch pulse LP, a polarity inversion signal POL, etc.

The scanning signal line drive circuit 3 selects in turn one scanning signal line from among the scanning signal lines G1 to G3m according to the control signals outputted from the display control circuit 2, and applies a gate-on voltage (a voltage that places write TFTs (Thin Film Transistors) in the pixel circuits 6 in anon state) to the selected scanning signal line. By this, n pixel circuits 6 disposed in the same row can be selected at a time.

The data rearranging circuit 5 rearranges data included in the video signal Da supplied from the outside of the liquid crystal display device 10, according to the order required by the data signal line drive circuit 4, and outputs a video signal Db obtained after the rearrangement.

The data signal line drive circuit 4 applies voltages based on the video signal Db to the data signal lines S1 to Sn, according to the control signals outputted from the display control circuit 2. By this, desired voltages can be written into the n pixel circuits 6 selected by the scanning signal line drive circuit 3, and accordingly, a desired image can be displayed. In addition, the data signal line drive circuit 4 reverses the polarities of voltages applied to the data signal lines S1 to Sn, on a line-by-line and frame-by-frame basis. By this, one-line inversion drive and frame inversion drive where the polarities of liquid crystal applied voltages are reversed on a line-by-line and frame-by-frame basis are performed, enabling to prevent screen burn-in.

Note that, in order to reduce size of the liquid crystal display device 10, all or some part of the display control circuit 2, the scanning signal line drive circuit 3, the data signal line drive circuit 4, and the data rearranging circuit 5 may be formed on the liquid crystal panel 1.

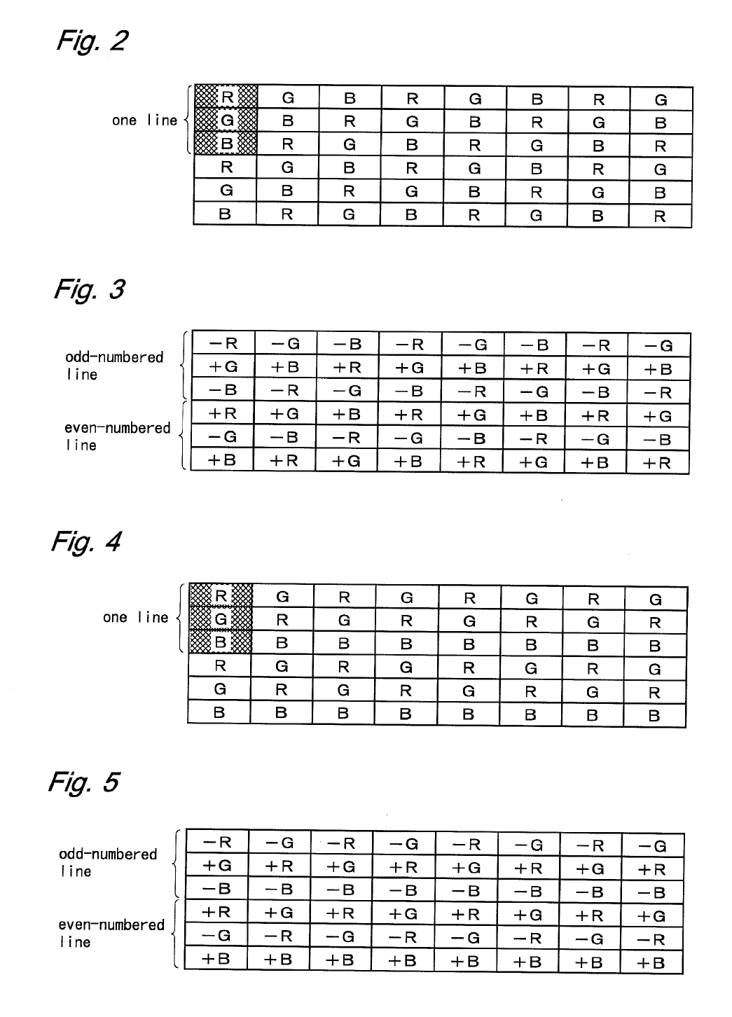

FIG. 2 is a diagram showing the disposition of pixel circuits 6 in the liquid crystal display device 10. In the liquid crystal display device 10, three pixel circuits 6 arranged in the column direction (a portion surrounded by a dashed line in FIG. 1 and a hatched portion in FIG. 2) each is associated with any of red, green, and blue, and the three pixel circuits 6 as a whole form one pixel. As shown in FIG. 2, in the leftmost pixel of each line, three pixel circuits are arranged in the order an R pixel circuit, a G pixel circuit, and a B pixel circuit from the top. In the second pixel from the left, three pixel circuits are arranged in the order a G pixel circuit, a B pixel circuit, and an R pixel circuit from the top. In the third pixel from the left, three pixel circuits are arranged in the order a B pixel circuit, an R pixel circuit, and a G pixel circuit from the top. For subsequent pixels, likewise, the above-described three types of pixels are repeatedly arranged in the row direction. As such, in the liquid crystal display device 10, the order of arrangement of the pixel circuits 6 differs between pixels adjacent to each other in the row direction. In the row direction, pixels where the order of arrangement of the pixel circuits 6 changes regularly are arranged. In the column direction, pixels where the order of arrangement of the pixel circuits 6 is the same are arranged.

FIG. 3 is a diagram showing the polarities of liquid crystal applied voltages in the liquid crystal display device 10. As shown in FIG. 3, for the odd-numbered lines, negative polarity voltages are applied to pixel circuits that are disposed at the top or bottom in three pixel circuits, and positive polarity voltages are applied to pixel circuits disposed therebetween. For the even-numbered lines, positive polarity voltages are applied to pixel circuits disposed at the top or bottom, and negative polarity voltages are applied to pixel circuits disposed therebetween. The data signal line drive circuit 4 also performs frame inversion drive, and thus, in the next frame, the polarities of liquid crystal applied voltages are reversed from those shown in FIG. 3.

As described above, in the liquid crystal display device 10, the order of arrangement of the pixel circuits 6 differs between pixels adjacent to each other in the row direction. Therefore, even when one-line inversion drive is performed using the data signal line drive circuit 4, in every line in a frame, positive polarity voltages are applied to some R pixel circuits and negative polarity voltages are applied to the other R pixel circuits. For example, in FIG. 3, negative polarity voltages are applied to those R pixel circuits included in the leftmost pixel or the second pixel from the left of each odd-numbered line, and a positive polarity voltage is applied to an R pixel circuit included in the third pixel from the left in the odd-numbered line. By thus applying voltages of different polarities to R pixel circuits in each line in each frame, the influence of the polarities of the applied voltages can be canceled out for red on a display screen. Likewise, by applying voltages of different polarities to G pixel circuits and B pixel circuits in each line in each frame, the influence of the polarities of the applied voltages can be canceled out for green and blue on the display screen.

Therefore, according to the liquid crystal display device 10 according to the present embodiment, when one-line inversion drive is performed by a liquid crystal display device including pixel circuits associated with red, green, and blue which are longer in the row direction than in the column direction, voltages of different polarities are applied to three types of pixel circuits 6 in each line in each frame to cancel out the influence of the polarities of the applied voltages, whereby a color shift can be suppressed. In particular, by arranging, in the row direction, pixels where the order of arrangement of the pixel circuits 6 changes regularly, voltages of different polarities are regularly applied to three types of pixel circuits 6 in each line in each frame to suitably cancel out the influence of the polarities of the applied voltages, whereby a color shift can be effectively suppressed.

Note that, for the liquid crystal display device 10 according to the present embodiment, various variants with different dispositions of the pixel circuits 6 can be formed. FIG. 4 is a diagram showing the disposition of pixel circuits in a liquid crystal display device according to a first variant. As shown in FIG. 4, in the leftmost pixel of each line, three pixel circuits are arranged in the order an R pixel circuit, a G pixel circuit, and a B pixel circuit from the top. In the second pixel from the left, three pixel circuits are arranged in the order a G pixel circuit, an R pixel circuit, and a B pixel circuit from the top. For subsequent pixels, likewise, the above-described two types of pixels are repeatedly arranged in the row direction. The polarities of liquid crystal applied voltages for this case are as shown in FIG. 5.

In the liquid crystal display device according to the first variant, when one-line inversion drive is performed, the polarities of applied voltages can be canceled out better for red and green on a display screen, but the polarities of applied voltages cannot be canceled out for blue. However, humans are less sensitive to blue compared to red and green. Therefore, as shown in FIG. 5, by alternately applying voltages of different polarities to pixel circuits associated with red and green to which human has high sensitivity, in each line in each frame, the influence of the polarities of the applied voltages is suitably canceled out, whereby a color shift can be effectively suppressed.

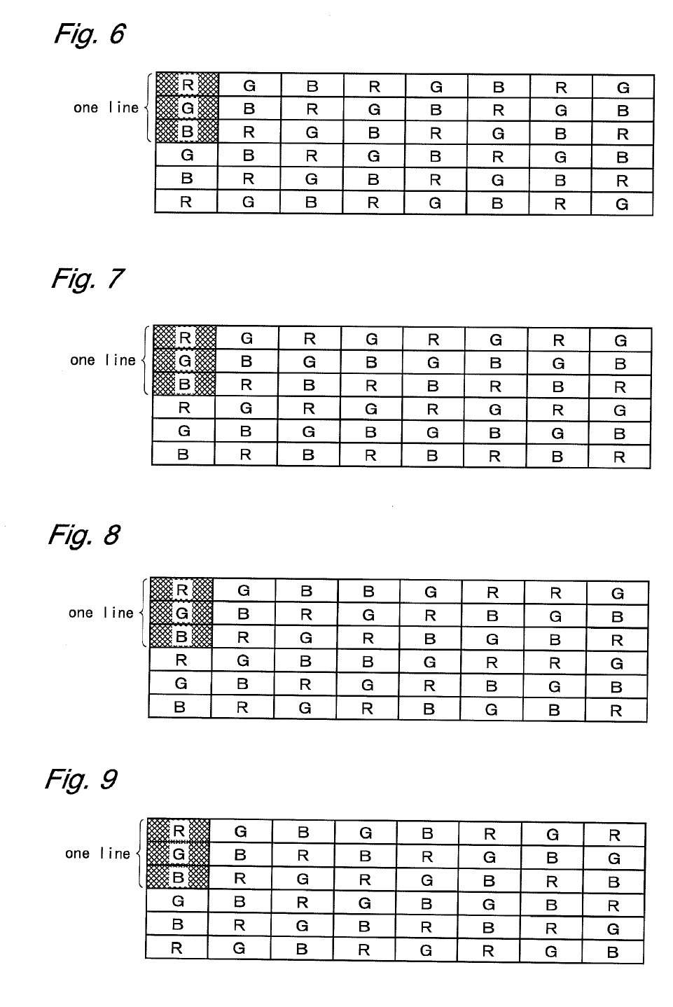

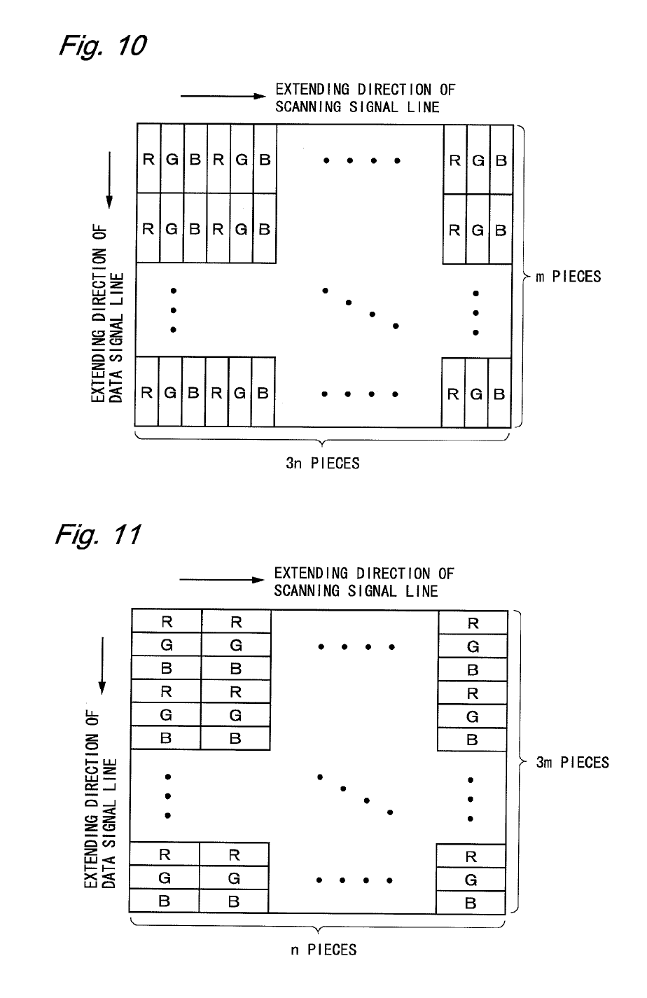

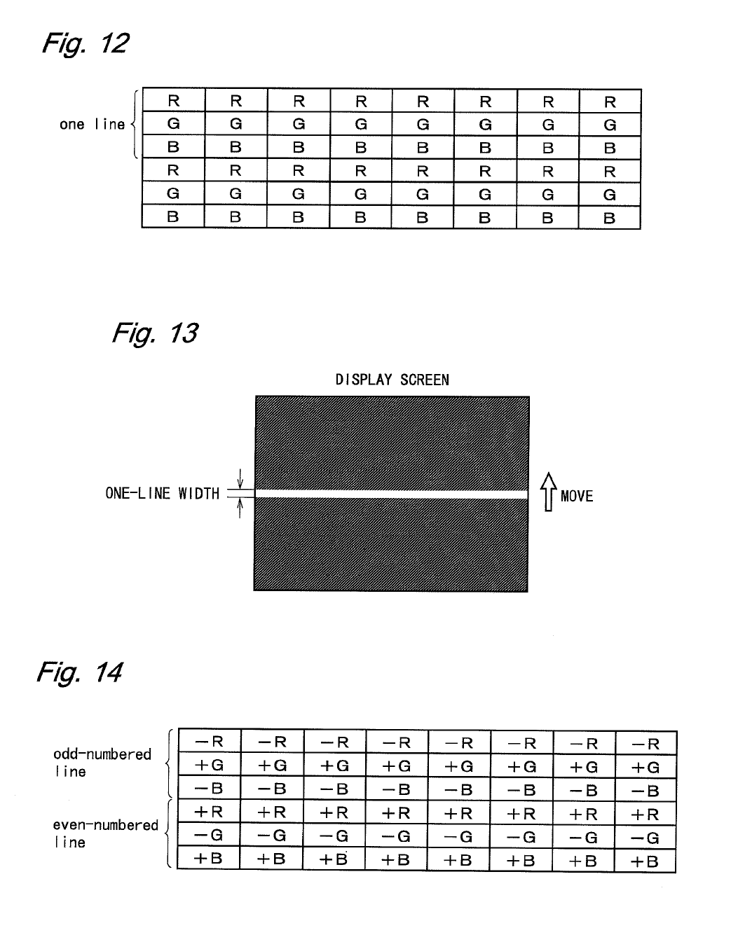

FIGS. 6 to 9 are diagrams showing the dispositions of pixel circuits in liquid crystal display devices according to second to fifth variants, respectively. In a liquid crystal display device according to the second variant (FIG. 6), pixels with different orders of arrangement of pixel circuits 6 are arranged in the column direction. In a liquid crystal display device according to the third variant (FIG. 7), pixels each having three pixel circuits arranged in the order red, green and blue and pixels each having three pixel circuits arranged in the order green, blue, and red are arranged in the row direction. In a liquid crystal display device according to the fourth variant (FIG. 8), six types of pixels, including a pixel having three pixel circuits arranged in the order blue, green, and red, etc., are arranged in the row direction. In a liquid crystal display device according to the fifth variant (FIG. 9), three types of pixels which are the same as those shown in FIG. 2 are arranged irregularly in the row and column directions. In the liquid crystal display devices according to these variants, too, since the order of arrangement of pixel circuits differs between pixels adjacent to each other in the extending direction of scanning signal lines, a color shift can be suppressed as does the liquid crystal display device 10.

Although, in the above description, a liquid crystal display device includes three types of pixel circuits associated with red, green, and blue, the liquid crystal display device may include pixel circuits associated with other colors than those described above, and may include pixel circuits associated with four or more different colors. Also, the present invention can be applied to image display devices other than liquid crystal display devices.

As described above, according to an image display device of the present invention, the order of arrangement of pixel circuits differs between pixels adjacent to each other in an extending direction of scanning signal lines. Thus, when line inversion drive is performed, voltages of different polarities are applied to pixel circuits associated with the respective colors in each line in each frame to cancel out the influence of the polarities of the applied voltages, whereby a color shift can be suppressed.

### INDUSTRIAL APPLICABILITY

The image display device of the present invention has the effect of being able to suppress a color shift which occurs when line inversion drive is performed, and thus, can be used as various image display devices such as a liquid crystal display device.

### DESCRIPTION OF REFERENCE NUMERALS

1: LIQUID CRYSTAL PANEL
2: DISPLAY CONTROL CIRCUIT
3: SCANNING SIGNAL LINE DRIVE CIRCUIT
4: DATA SIGNAL LINE DRIVE CIRCUIT
5: DATA REARRANGING CIRCUIT
6: PIXEL CIRCUIT
10: LIQUID CRYSTAL DISPLAY DEVICE

1. An image display device that performs color display, the image display device comprising:
a plurality of scanning signal lines extending in a first direction;
a plurality of data signal lines extending in a second direction;
a plurality of pixel circuits provided at respective intersections of the scanning signal lines and the data signal lines, the pixel circuits being longer in the first direction than in the second direction;
a scanning signal line drive circuit that selects the scanning signal lines in turn; and
a data signal line drive circuit that applies voltages based on a video signal to the data signal lines such that polarities of the voltages are switched every one or more data signal lines, wherein
a predetermined number of pixel circuits arranged in the second direction each are associated with a given color, and as a whole form one pixel, and an order of arrangement of pixel circuits differs between pixels adjacent to each other in the first direction.

2. The image display device according to claim 1, wherein pixels where an order of arrangement of pixel circuits changes regularly are arranged in the first direction.

3. The image display device according to claim 2, wherein a pixel having three pixel circuits arranged in an order red, green, and blue, a pixel having three pixel circuits arranged in an order green, blue, and red, and a pixel having three pixel circuits arranged in an order blue, red, and green are repeatedly arranged in the first direction, the three pixel circuits being associated with red, green, and blue.

4. The image display device according to claim 2, wherein a pixel having three pixel circuits arranged in an order red, green, and blue and a pixel having three pixel circuits arranged in an order green, red, and blue are alternately arranged in the first direction, the three pixel circuits being associated with red, green, and blue.

5. The image display device according to claim 1, wherein pixels with the same order of arrangement of pixel circuits are arranged in the second direction.

6. The image display device according to claim 1, wherein the data signal line drive circuit applies the voltages based on the video signal to the data signal lines such that the polarities of the voltages are switched every one data signal line.
